(19) United States
(12) Patent Application Publication
(10) Pub. No.: US 2012/0231840 A1
(43) Pub. Date: Sep. 13, 2012

(54) PROVIDING INFORMATION REGARDING SPORTS MOVEMENTS

(75) Inventors: Matthew A. Calman, Charlotte, NC (US); Erik Stephen Ross, Charlotte, NC (US)

(73) Assignee: BANK OF AMERICA CORPORATION, Charlotte, NC (US)

(21) Appl. No.: 13/342,063

(22) Filed: Jan. 1, 2012

Related U.S. Application Data
(60) Provisional application No. 61/450,213, filed on Mar. 8, 2011.
(60) Provisional application No. 61/508,821, filed on Jul. 18, 2011.

(51) Int. Cl. H04W 88/02

(52) U.S. Cl. 455/556.1

(57) ABSTRACT

Systems, methods, and computer program products are provided for using real-time video analysis, such as AR or the like to assist the user of a mobile device with commerce activities. Through the use of real-time vision object recognition faces, physical features, objects, logos, artwork, products, locations and other features that can be recognized in the real-time video stream can be matched to data associated with such to assist the user with commerce activity. The commerce activity may include, but is not limited to: providing information regarding sports movements, analyzing movements associated with sports or exercises, providing information and recommendations regarding techniques and equipment, and supplying information about locations where equipment may be purchased. In specific embodiments, the data that is matched to the images in the real-time video stream is specific to financial institutions, such as customer financial behavior history, customer purchase power/transaction history and the like.

### CROSS-REFERENCE TO RELATED APPLICATIONS

This application claims priority to U.S. Provisional Patent Application Ser. No. 61/450,213, filed Mar. 8, 2011, entitled “Real-Time Video Image Analysis Applications for Commerce Activity,” and U.S. Provisional Patent Application Ser. No. 61/508,821, filed Jul. 18, 2011, entitled “Providing Information Regarding Sports Movements,” the entirety of each of which is incorporated herein by reference.

### BACKGROUND

Modern handheld mobile devices, such as smart phones or the like, combine multiple technologies to provide the user with a vast array of capabilities. For example, many smart phones are equipped with significant processing power, sophisticated multi-tasking operating systems, and high-bandwidth Internet connection capabilities. Moreover, such devices often have additional features that are becoming increasingly more common and standardized. Such features include, but are not limited to, location-determining devices, such as Global Positioning System (GPS) devices; sensor devices, such as accelerometers; and high-resolution video cameras.

As the hardware capabilities of such mobile devices have increased, so too have the applications (i.e., software) that rely on the hardware advances. One such example of innovative software is a category known as augmented reality (AR), or more generally referred to as mediated reality. One such example of an AR application platform is Layar, available from Layar, Amsterdam, the Netherlands.

The Layar platform technology analyzes location data, compass direction data, and the like in combination with information related to the objects, locations or the like in the video stream to create browse-able “hot-spots” or “tags” that are superimposed on the mobile device display, resulting in an experience described as “reality browsing”.

The popularity of handheld mobile devices has grown in parallel with public awareness of the importance of incorporating exercise into a healthy lifestyle. In an effort to improve personal health, stave off injuries and diseases associated with age and other factors, and enhance the enjoyment of life, many people have turned to a variety of sports and other exercise-related activities. Accordingly, advancements in the study of biomechanics, kinesiology, sports medicine, and athletic training have expanded our understanding of complex differences between the physiology of individuals, and of how a body can and should move during various sports and exercise activities to achieve the desired results with lower risks of injury. In applying such advancements, many equipment manufactures have developed wide arrays of specialized equipment designed to allow individuals to achieve their own optimum performance in sports and exercise activities.

While consumers of sports and exercise equipment now have more options than ever, the significant degree of specialization and variability in such equipment, coupled with the ever-expanding body of available information has made it difficult for consumers to rapidly assess their own needs and identify products that are most appropriate for their own purposes.

Therefore, a need exists to assist the user of mobile communication devices with acquiring information about sports and exercise movements and applying that information to a selection of equipment.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, apparatus systems and computer program products are described herein that provide for using video analysis, such as AR or the like to assist the user of mobile devices with obtaining information regarding sports or exercise movements.

In one aspect, the invention provides a method. Example embodiments of methods in accordance with this aspect include recognizing information associated with an image, wherein the image was captured by a mobile device of a user; determining, based at least partially on the information, that the image depicts a portion of a movement, wherein the movement is associated with a sport or an exercise; and presenting via the mobile device of the user information associated with the portion of a movement.

In some example implementations of such a method, the movement includes a running motion. In some of these implementations, and in other example implementations, the movement includes jumping motion.

In some other example implementations, the movement includes a throwing motion. In some such implementations, and in other example implementations, the movement includes a catching motion. In some of these, and in other example implementations, the movement includes a striking motion. In other example implementations, the movement includes a swinging motion.

In some other example implementations, the movement includes a kicking motion. In some such example implementations, and in other example implementations, the movement includes a swimming motion.

In some other example implementations, the movement includes a twisting motion. In some such implementations, and in other example implementations, the movement includes a positioning of a body part.

In some example implementations, the movement includes a pushing motion. In some such implementations and in other example implementations, the movement includes a pulling motion.

In some example implementations, the movement includes an extension of a body part. In some such implementations, and in other example implementations, the movement includes a flexion of a body part.

In some example implementations, the information associated with the portion of a movement includes an analysis of the portion of a movement. In some such implementations, and in other example implementations, the information associated with the portion of a movement includes an item of equipment.

Some example implementations of a method include receiving via the mobile device of the user information associated with a plurality of items of equipment; comparing the information associated with the portion of a movement with the information associated with the plurality of items of equipment; and presenting via the mobile device of the user information associated with a portion of the plurality of items of equipment.

In some such example implementations, and in other example implementations, the information associated with a portion of the plurality of items of equipment comprises a recommendation of one or more items within the plurality of items of equipment. In some such example implementations, and in other example implementations, a method further includes receiving via the mobile device of the user a piece of location information associated with the recommendation of one or more items within the plurality of items of equipment; and presenting via the mobile device of the user the piece of location information.

In another aspect, the invention provides an apparatus. Example embodiments of apparatuses in accordance with this aspect include a computing device comprising a memory and at least one processor, and a sports movement information application stored in memory, executable by the processor, and configured to recognize information associated with an image, wherein the image was captured by a mobile device of a user, determine, based at least partially on the information, that the image depicts a portion of a movement, wherein the movement is associated with a sport or an exercise, and present via the mobile device of the user information associated with the portion of a movement.

In some example implementation, the movement comprises a running motion. In some such example implementations, and in other example implementations, the movement comprises a jumping motion.

In some example implementations, the movement comprises a throwing motion. In some such example implementations, and in other example implementations, movement comprises a catching motion.

In some example implementations, the movement comprises striking motion. In some such example implementations, and in other example implementations, the movement comprises a swinging motion. In some such example implementations, and in other example implementations, the movement comprises a kicking motion.

In some example implementations, the movement comprises a swimming motion.

In some example implementations, the movement comprises a twisting motion.

In some example implementations, the movement comprises a position of a body part.

In some example implementations, the movement comprises a pushing motion. In some such example implementations, and in other example implementations, the movement comprises a pulling motion. In some such example implementations, and in other example implementations, the movement comprises an extension of a body part. In some such example implementations, and in other example implementations, the movement comprises a flexion of a body part.

In some example implementations, the information associated with the portion of a movement comprises an analysis of the portion of a movement. In some such example implementations, and in other example implementations, the information associated with the portion of a movement comprises an item of equipment.

In some example implementations, the sports movement information application is further configured to receive via the mobile device of the user information associated with a plurality of items of equipment, compare the information associated with the portion of a movement with the information associated with the plurality of items of equipment; and present via the mobile device of the user information associated with a portion of the plurality of items of equipment. In some such example implementations and in other example implementations, the information associated with a portion of the plurality of items of equipment comprises a recommendation of one or more items within the plurality of items of equipment. In some such example implementations and in other example implementations, the sports movement information application is further configured to receive via the mobile device of the user a piece of location information associated with the recommendation of one or more items within the plurality of items of equipment, and present via the mobile device of the user the piece of location information.

In another aspect, the invention provides computer program products. Example embodiments of computer program products in accordance with this aspect include a non-transitory computer-readable medium comprising a first set of codes for causing a computer processor to be configured for recognizing information associated with an image, wherein the image was captured by a mobile device of a user, a second set of codes for causing a computer processor to be configured for determining, based at least partially on the information, that the image depicts a portion of a movement, wherein the movement is associated with a sport or an exercise, and a third set of codes for causing a computer processor to be configured for presenting via the mobile device of the user information associated with the portion of a movement.

In some example implementations, the movement comprises a running motion. In some such example implementations and in other example implementations, the movement comprises a jumping motion.

In some example implementations, movement comprises a throwing motion. In some such example implementations, and in other example implementations, the movement comprises a catching motion.

In some example implementations, the movement comprises striking motion. In some such example implementations, and in other example implementations, the movement comprises a swinging motion. In some such example implementations, and in other example implementations, the movement comprises a kicking motion.

In some example implementations, the movement comprises a swimming motion.

In some example implementations, the movement comprises a twisting motion.

In some example implementations, the movement comprises a position of a body part.

In some example implementations, the movement comprises a pushing motion. In some such example implementations, and in other example implementations, the movement comprises a pulling motion. In some such example implementations, and in other example implementations, the movement comprises an extension of a body part. In some such example implementations, and in other example implementations, the movement comprises a flexion of a body part.

In some example implementations, the information associated with the portion of a movement comprises an analysis of the portion of a movement. In some such example implementations, and in other example implementations, the information associated with the portion of a movement comprises an item of equipment.

In some example implementations, the computer program product further includes a fourth set of codes for causing a computer processor to be configured for receiving via the mobile device of the user information associated with a plurality of items of equipment, a fifth set of codes for causing a computer processor to be configured for comparing the information associated with the portion of a movement with the information associated with the plurality of items of equipment, and a sixth set of codes for causing a computer processor to be configured for presenting via the mobile device of the user information associated with a portion of the plurality of items of equipment. In some such example implementations, and in other example implementations, the information associated with a portion of the plurality of items of equipment comprises a recommendation of one or more items within the plurality of items of equipment. In some such example implementations, and in other example implementations, the computer program product further includes a set of codes for causing a computer processor to be configured for receiving via the mobile device of the user a piece of location information associated with the recommendation of one or more items within the plurality of items of equipment, and a set of codes for causing a computer processor to be configured for presenting via the mobile device of the user the piece of location information.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating a mobile device, in accordance with an embodiment of the invention;

FIG. 2 is a block diagram illustrating an AR environment, in accordance with an embodiment of the invention;

FIG. 3 is a block diagram illustrating a mobile device, in accordance with an embodiment of the invention;

FIG. 4 is a schematic diagram illustrating a process flow providing information about a sports or exercise motion in conjunction with an image captured by the mobile device, in accordance with an embodiment of the invention; and

FIG. 5 is a schematic diagram illustrating a process flow providing information about a sports or exercise motion in conjunction with an image captured by the mobile device, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, methods, systems, computer programs and the like are herein disclosed that provide for using real-time video analysis, such as AR or the like to assist the user of mobile devices with identifying individuals associated with the user, identifying locations associated with individuals who are associated with the user, and identifying the location of a plurality of individuals who share a trait. Through the use of real-time vision object recognition, objects, logos, artwork, products, locations and other features that can be recognized in the real-time video stream can be matched to data associated with such to assist the user with activities and methods described herein. In specific embodiments, the data that is matched to the images in the real-time video stream is specific to financial institutions, such as customer financial behavior history, customer purchase power/transaction history and the like. In this regard, many of the embodiments herein disclosed leverage financial institution data, which is uniquely specific to financial institution, in providing information to mobile devices users in connection with real-time video stream analysis.

In yet other embodiments, real-time video analysis, such as AR or the like may be used to assist the user of a mobile device for identifying individuals dynamically, such that two individuals whom are looking for similar features may find each other. The user may input data on the mobile device, such as interests, location, etc. of the user. That data of may be dynamically matched to data of a second user, such that the users may discover each other based on the data provided. For example, if two users are at a conference where they do not know anyone, but would like to network with other individuals at the conference. The two users may provide data to the system such that the two users may seek each other during the conference. The system could match the two users at the conference and provide each of them the name, details, etc. in regard to the other user.

While embodiments discussed herein are generally described with respect to “real-time video streams” or “real-time video” it will be appreciated that the video stream may be captured and stored for later viewing and analysis. Indeed, in some embodiments video is recorded and stored on a mobile device and portions or the entirety of the video may be analyzed at a later time. The later analysis may be conducted on the mobile device or loaded onto a different device for analysis. The portions of the video that may be stored and analyzed may range from a single frame of video (e.g., a screenshot) to the entirety of the video. Additionally, rather than video, the user may opt to take a still picture of the environment to be analyzed immediately or at a later time. Embodiments in which real-time video, recorded video or still pictures are analyzed are contemplated herein.

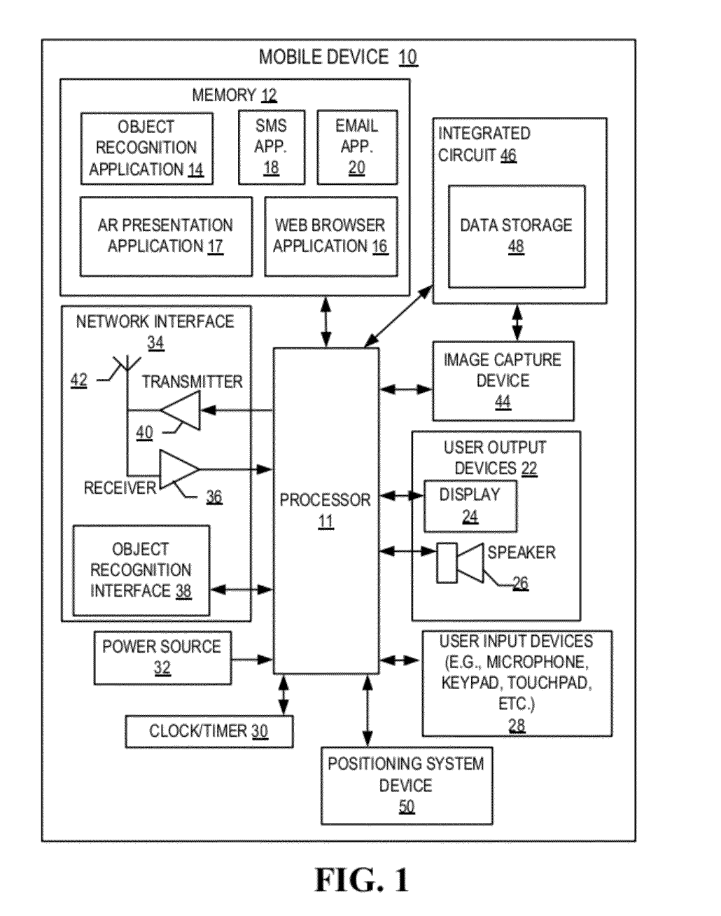

FIG. 1 illustrates an embodiment of a mobile device 10 that may be configured to execute object recognition and Augmented Reality (AR) functionality, in accordance with specific embodiments of the present invention. A “mobile device” 10 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The mobile device 10 may generally include a processor 11 communicably coupled to such devices as a memory 12, user output devices 22, user input devices 28, a network interface 34, a power source 32, a clock or other timer 30, an image capture device 44, a positioning system device 50 (e.g., a Global Positioning System (GPS) device), one or more integrated circuits 46, etc.

In some embodiments, the mobile device and/or the server access one or more databases or data stores (not shown in FIG. 1) to search for and/or retrieve information related to the object and/or marker. In some embodiments, the mobile device and/or the server access one or more data stores local to the mobile device and/or server and in other embodiments, the mobile device and/or server access data stores remote to the mobile device and/or server. In some embodiments, the mobile device and/or server access both a memory and/or data store local to the mobile device and/or server as well as a data store remote from the mobile device and/or server.

The processor 11, and other processors described herein, may generally include circuitry for implementing communication and/or logic functions of the mobile device 10. For example, the processor 11 may include a digital signal processor device, a microprocessor device, and various analog to digital converters, digital to analog converters, and/or other support circuits. Control and signal processing functions of the mobile device 10 may be allocated between these devices according to their respective capabilities. The processor 11 thus may also include the functionality to encode and interleave messages and data prior to modulation and transmission. The processor 11 may additionally include an internal data modem. Further, the processor 11 may include functionality to operate one or more software programs or applications, which may be stored in the memory 12. For example, the processor 11 may be capable of operating a connectivity program, such as a web browser application 16. The web browser application 16 may then allow the mobile device 10 to transmit and receive web content, such as, for example, location-based content and/or other web page content, according to a Wireless Application Protocol (WAP), Hypertext Transfer Protocol (HTTP), and/or the like.

The processor 11 may also be capable of operating applications, such as an object recognition application 14. The object recognition application 14 may be downloaded from a server and stored in the memory 12 of the mobile device 10. Alternatively, the object recognition application 14 may be pre-installed and stored in a memory in the integrated circuit 46. In such an embodiment, the user may not need to download the object recognition application 14 from a server. In some embodiments, the processor 11 may also be capable of operating one or more applications, such as one or more applications functioning as an artificial intelligence (“AI”) engine. The processor 11 may recognize objects that it has identified in prior uses by way of the AI engine. In this way, the processor 11 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other modules or applications described herein to perform the various steps of the methods discussed. For example, in some embodiments, the AI engine recognizes an object that has been recognized before and stored by the AI engine. The AI engine may then communicate to another application or module of the mobile device and/or server, an indication that the object may be the same object previously recognized. In this regard, the AI engine may provide a baseline or starting point from which to determine the nature of the object. In other embodiments, the AI engine's recognition of an object is accepted as the final recognition of the object.

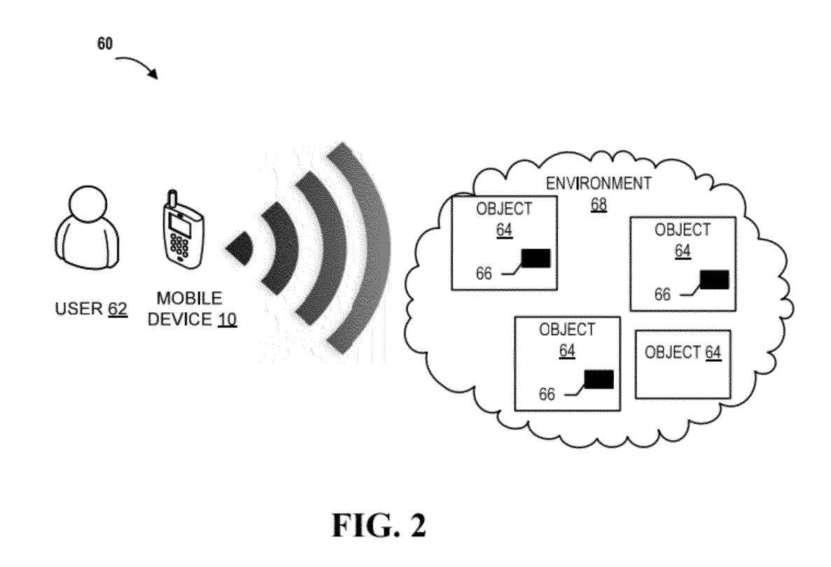

The integrated circuit 46 may include the necessary circuitry to provide the object recognition functionality to the mobile device 10. Generally, the integrated circuit 46 will include data storage 48 which may include data associated with the objects within a video stream that the object recognition application 14 identifies as having a certain marker(s) (discussed in relation to FIG. 2). The integrated circuit 46 and/or data storage 48 may be an integrated circuit, a microprocessor, a system-on-a-integrated circuit, a microcontroller, or the like. As discussed above, in one embodiment, the integrated circuit 46 may provide the functionality to the mobile device 10.

Of note, while FIG. 1 illustrates the integrated circuit 46 as a separate and distinct element within the mobile device 10, it will be apparent to those skilled in the art that the object recognition functionality of integrated circuit 46 may be incorporated within other elements in the mobile device 10. For instance, the functionality of the integrated circuit 46 may be incorporated within the mobile device memory 12 and/or processor 11. In a particular embodiment, the functionality of the integrated circuit 46 is incorporated in an element within the mobile device 10 that provides object recognition capabilities to the mobile device 10. Still further, the integrated circuit 46 functionality may be included in a removable storage device such as an SD card or the like.

The processor 11 may be configured to use the network interface 34 to communicate with one or more other devices on a network. In this regard, the network interface 34 may include an antenna 42 operatively coupled to a transmitter 40 and a receiver 36 (together a “transceiver”). The processor 11 may be configured to provide signals to and receive signals from the transmitter 40 and receiver 36, respectively. The signals may include signaling information in accordance with the air interface standard of the applicable cellular system of the wireless telephone network that may be part of the network. In this regard, the mobile device 10 may be configured to operate with one or more air interface standards, communication protocols, modulation types, and access types. By way of illustration, the mobile device 10 may be configured to operate in accordance with any of a number of first, second, third, and/or fourth-generation communication protocols and/or the like. For example, the mobile device 10 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 10 may also be configured to operate in accordance with non-cellular communication mechanisms, such as via a wireless local area network (WLAN) or other communication/data networks.

The network interface 34 may also include an object recognition interface 38 in order to allow a user to execute some or all of the above-described processes with respect to the object recognition application 14 and/or the integrated circuit 46. The object recognition interface 38 may have access to the hardware, e.g., the transceiver, and software previously described with respect to the network interface 34. Furthermore, the object recognition interface 38 may have the ability to connect to and communicate with an external data storage on a separate system within the network as a means of recognizing the object(s) in the video stream.

As described above, the mobile device 100 may have a user interface that includes user output devices 22 and/or user input devices 28. The user output devices 22 may include a display 24 (e.g., a liquid crystal display (LCD) or the like) and a speaker 26 or other audio device, which are operatively coupled to the processor 11. The user input devices 28, which may allow the mobile device 10 to receive data from a user, may include any of a number of devices allowing the mobile device 10 to receive data from a user, such as a keypad, keyboard, touch-screen, touchpad, microphone, mouse, joystick, other pointer device, button, soft key, and/or other input device(s).

The mobile device 10 may further include a power source 32. Generally, the power source 32 is a device that supplies electrical energy to an electrical load. In one embodiment, power source 32 may convert a form of energy such as solar energy, chemical energy, mechanical energy, etc. to electrical energy. Generally, the power source 32 in a mobile device 10 may be a battery, such as a lithium battery, a nickel-metal hydride battery, or the like, that is used for powering various circuits, e.g., the transceiver circuit, and other devices that are used to operate the mobile device 10. Alternatively, the power source 32 may be a power adapter that can connect a power supply from a power outlet to the mobile device 10. In such embodiments, a power adapter may be classified as a power source “in” the mobile device.

The mobile device 10 may also include a memory 12 operatively coupled to the processor 11. As used herein, memory may include any computer readable medium configured to store data, code, or other information. The memory 12 may include volatile memory, such as volatile Random Access Memory (RAM) including a cache area for the temporary storage of data. The memory 12 may also include non-volatile memory, which can be embedded and/or may be removable. The non-volatile memory may additionally or alternatively include an electrically erasable programmable read-only memory (EEPROM), flash memory or the like.

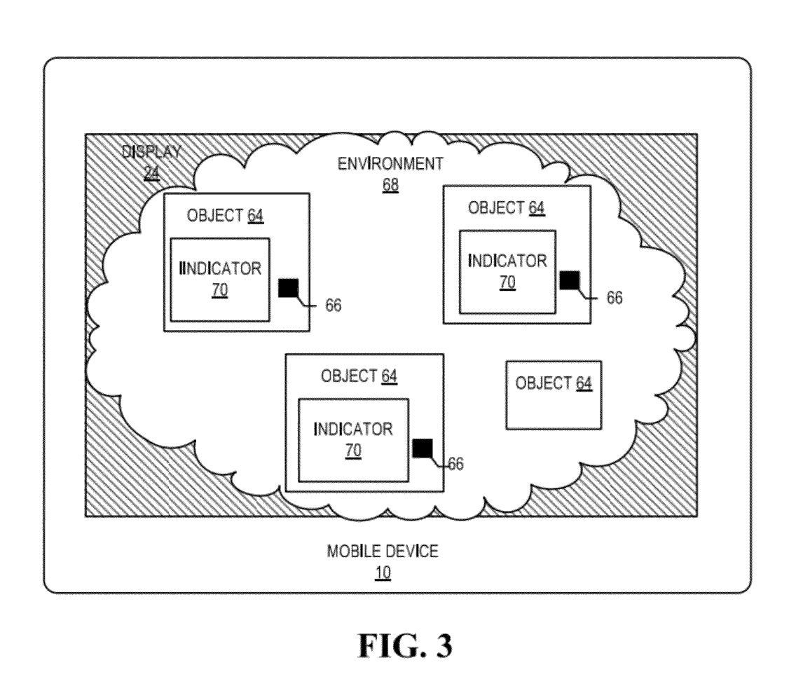

The memory 12 may store any of a number of applications or programs which comprise computer-executable instructions/code executed by the processor 11 to implement the functions of the mobile device 10 described herein. For example, the memory 12 may include such applications as an object recognition application 14, an augmented reality (AR) presentation application 17 (described infra. in relation to FIG. 3), a web browser application 16, a Short Message Service (SMS) application 18, an electronic mail (i.e., email) application 20, etc.

Referring to FIG. 2, a block diagram illustrating an object recognition experience 60 in which a user 62 utilizes a mobile device 10 to capture a video stream that includes an environment 68 is shown. As denoted earlier, the mobile device 10 may be any mobile communication device. The mobile device 10 has the capability of capturing a video stream of the surrounding environment 68. The video capture may be by any means known in the art. In one particular embodiment, the mobile device 10 is a mobile telephone equipped with an image capture device 44 capable of video capture.

The environment 68 contains a number of objects 64. Some of such objects 64 may include a marker 66 identifiable to an object recognition application that is either executed on the mobile device 10 or within the wireless network. A marker 66 may be any type of marker that is a distinguishing feature that can be interpreted by the object recognition application to identify specific objects 64. For instance, a marker 66 may be alpha-numeric characters, symbols, logos, shapes, ratio of size of one feature to another feature, a product identifying code such as a bar code, electromagnetic radiation such as radio waves (e.g., radio frequency identification (RFID)), architectural features, color, etc. In some embodiments, the marker 66 may be audio and the mobile device 10 may be capable of utilizing audio recognition to identify words or unique sounds broadcast. The marker 66 may be any size, shape, etc. Indeed, in some embodiments, the marker 66 may be very small relative to the object 64 such as the alpha-numeric characters that identify the name or model of an object 64, whereas, in other embodiments, the marker 66 is the entire object 64 such as the unique shape, size, structure, etc.

In some embodiments, the marker 66 is not actually a physical marker located on or being broadcast by the object 64. For instance, the marker 66 may be some type of identifiable feature that is an indication that the object 64 is nearby. In some embodiments, the marker 66 for an object 64 may actually be the marker 66 for a different object 64. For example, the mobile device 10 may recognize a particular building as being “Building A.” Data stored in the data storage 48 may indicate that “Building B” is located directly to the east and next to “Building A.” Thus, markers 66 for an object 64 that are not located on or being broadcast by the object 64 are generally based on fixed facts about the object 64 (e.g., “Building B” is next to “Building A”). However, it is not a requirement that such a marker 66 be such a fixed fact. The marker 66 may be anything that enables the mobile device 10 and associated applications to interpret to a desired confidence level what the object is. For another example, the mobile device 10, object recognition application 14 and/or AR presentation application 17 may be used to identify a particular person as a first character from a popular show, and thereafter utilize the information that the first character is nearby features of other characters to interpret that a second character, a third character, etc. are nearby, whereas without the identification of the first character, the features of the second and third characters may not have been used to identify the second and third characters. This example may also be applied to objects outside of people.

The marker 66 may also be or include social network data, such as data retrieved or communicated from the Internet, such as tweets, blog posts, social networking or other online posts, various types of messages and/or the like. In other embodiments, the marker 66 is provided in addition to social network data as mentioned above. For example, the mobile device 10 may capture a video stream and/or one or more still shots of a large gathering of people. In this example, as above, one or more people dressed as characters in costumes may be present at a specified location. The mobile device 10, object recognition application 14, and/or the AR presentation application 17 may identify several social network indicators, such as posts, blogs, tweets, messages, and/or the like indicating the presence of one or more of the characters at the specified location. In this way, the mobile device 10 and associated applications may communicate information regarding the social media communications to the user and/or use the information regarding the social media communications in conjunction with other methods of object recognition. For example, the mobile device 10 object recognition application 14, and/or the AR presentation application 17 performing recognition of the characters at the specified location may confirm that the characters being identified are in fact the correct characters based on the retrieved social media communications. This example may also be applied objects outside of people.

In some embodiments, the mobile device and/or server access one or more other servers, social media networks, applications and/or the like in order to retrieve and/or search for information useful in performing an object recognition. In some embodiments, the mobile device and/or server accesses another application by way of an application programming interface or API. In this regard, the mobile device and/or server may quickly search and/or retrieve information from the other program without requiring additional authentication steps or other gateway steps.

While FIG. 2 illustrates that the objects 64 with markers 66 only include a single marker 66, it will be appreciated that the object 64 may have any number of markers 66 with each equally capable of identifying the object 66. Similarly, multiple markers 66 may be identified by the mobile device 10 and associated applications such that the combination of the markers 66 may be utilized to identify the object 64. For example, the mobile device 10 may utilize facial recognition markers 66 to identify a person and/or utilize a separate marker 66, such as the clothes the person is wearing to confirm the identification to the desired confidence level that the person is in fact the person the mobile device identified. For example, the facial recognition may identify a person as a famous athlete, and thereafter utilize the uniform the person is wearing to confirm that it is in fact the famous athlete.

In some embodiments, a marker 66 may be the location of the object 64. In such embodiments, the mobile device 10 may utilize Global Positioning System (GPS) hardware and/or software or some other location determining mechanism to determine the location of the user 62 and/or object 64. As noted above, a location-based marker 66 could be utilized in conjunction with other non-location-based markers 66 identifiable and recognized by the mobile device 10 to identify the object 64. However, in some embodiments, a location-based marker may be the only marker 66. For instance, in such embodiments, the mobile device 10 may utilize GPS software to determine the location of the user 62 and a compass device or software to determine what direction the mobile device 10 is facing in order to identify the object 64. In still further embodiments, the mobile device 10 does not utilize any GPS data in the identification. In such embodiments, markers 66 utilized to identify the object 64 are not location-based.

FIG. 3 illustrates a mobile device 10, specifically the display 24 of the mobile 10, wherein the device 10 has executed an object recognition application 14 and an AR presentation application 17 to present within the display 24 indications of recognized objects within the live video stream (i.e., surrounding environment 68). The mobile device 10 is configured to rely on markers 66 to identify objects 64 that are associated with product offers, products with extended warranties, new products and the like, and indicate to the user 62 the identified objects 64 by displaying an indicator 70 on the mobile device display 130 in conjunction with display of the live video stream. As illustrated, if an object 64 does not have any markers 66 (or at least enough markers 66 to yield object identification), the object 64 will be displayed without an associated indicator 70.

The object recognition application 14 may use any type of means in order to identify desired objects 64. For instance, the object recognition application 14 may utilize one or more pattern recognition algorithms to analyze objects in the environment 68 and compare with markers 66 in data storage 48 which may be contained within the mobile device 10 (such as within integrated circuit 46) or externally on a separate system accessible via the connected network. For example, the pattern recognition algorithms may include decision trees, logistic regression, Bayes classifiers, support vector machines, kernel estimation, perceptrons, clustering algorithms, regression algorithms, categorical sequence labeling algorithms, real-valued sequence labeling algorithms, parsing algorithms, general algorithms for predicting arbitrarily-structured labels such as Bayesian networks and Markov random fields, ensemble learning algorithms such as bootstrap aggregating, boosting, ensemble averaging, combinations thereof, and the like.

Upon identifying an object 64 within the real-time video stream, the AR presentation application 17 is configured to superimpose an indicator 70 on the mobile device display 24. The indicator 70 is generally a graphical representation that highlights or outlines the object 64 and may be activatable (i.e., include an embedded link), such that the user 62 may “select” the indicator 70 and retrieve information related to the identified object. The information may include any desired information associated with the selected object and may range from basic information to greatly detailed information. In some embodiments, the indicator 70 may provide the user 62 with an internet hyperlink to further information on the object 64. The information may include, for example, all types of media, such as text, images, clipart, video clips, movies, or any other type of information desired. In yet other embodiments, the indicator 70 information related to the identified object may be visualized by the user 62 without “selecting” the indicator 70.

In embodiments in which the indicator 70 provides an interactive tab to the user 62, the user 62 may select the indicator 70 by any conventional means, e.g., keystroke, touch, voice command or the like, for interaction with the mobile device 10. For instance, in some embodiments, the user 62 may utilize an input device 28 such as a keyboard to highlight and select the indicator 70 in order to retrieve the information. In a particular embodiment, the mobile device display 24 includes a touch screen that the user may employ to select the indicator 70 utilizing the user's finger, a stylus, or the like.

In some embodiments, the indicator 70 is not be interactive and simply provides information to the user 62 by superimposing the indicator 70 onto the display 24. For example, in some instances it may be beneficial for the AR presentation application 17 to merely identify an object 64, e.g., just identify the object's name/title, give brief information about the object, etc., rather than provide extensive detail that requires interaction with the indicator 70. The AR presentation application 17 is capable of being tailored to a user's desired preferences.

Furthermore, the indicator 70 may be displayed at any size on the mobile device display 24. The indicator 70 may be small enough that it is positioned on or next to the object 64 being identified such that the object 64 remains discernable behind the indicator 70. Additionally, the indicator 70 may be semi-transparent or an outline of the object 64, such that the object 64 remains discernable behind or enclosed by the indicator 70. In other embodiments, the indicator 70 may be large enough to completely cover the object 64 portrayed on the display 24. Indeed, in some embodiments, the indicator 70 may cover a majority or the entirety of the mobile device display 24.

The user 62 may opt to execute the object recognition application 14 and AR presentation application 17 at any desired moment and begin video capture and analysis. However, in some embodiments, the object recognition application 14 and AR presentation application 17 includes an “always on” feature in which the mobile device 10 is continuously capturing video and analyzing the objects 64 within the video stream. In such embodiments, the object recognition application 14 may be configured to alert the user 62 that a particular object 64 has been identified. The user 62 may set any number of user preferences to tailor the object recognition and AR presentation experience to their needs. For instance, the user 62 may opt to only be alerted if a certain particular object 64 is identified. Additionally, it will be appreciated that the “always on” feature in which video is continuously captured may consume the mobile device power source 32 more quickly. Thus, in some embodiments, the “always on” feature may disengage if a determined event occurs such as low power source 32, low levels of light for an extended period of time (e.g., such as if the mobile device 10 is in a user's pocket obstructing a clear view of the environment 68 from the mobile device 10), if the mobile device 10 remains stationary (thus receiving the same video stream) for an extended period of time, the user sets a certain time of day to disengage, etc. Conversely, if the “always on” feature is disengaged due to the occurrence of such an event, the user 62 may opt for the “always on” feature to re-engage after the duration of the disengaging event (e.g., power source 32 is re-charged, light levels are increased, etc.).

In some embodiments, the user 62 may identify objects 64 that the object recognition application 14 does not identify and add it to the data storage 48 with desired information in order to be identified and/or displayed in the future. For instance, the user 62 may select an unidentified object 64 and enter a name/title and/or any other desired information for the unidentified object 64. In such embodiments, the object recognition application 14 may detect/record certain markers 66 about the object so that the pattern recognition algorithm(s) (or other identification means) may detect the object 64 in the future. Furthermore, in cases where the object information is within the data storage 48, but the object recognition application 14 fails to identify the object 64 (e.g., one or more identifying characteristics or markers 66 of the object has changed since it was added to the data storage 48 or the marker 66 simply was not identified), the user 62 may select the object 64 and associate it with an object 64 already stored in the data storage 48. In such cases, the object recognition application 14 may be capable of updating the markers 66 for the object 64 in order to identify the object in future video streams.

In addition, in some embodiments, the user 62 may opt to edit the information or add to the information provided by the indicator 70. For instance, the user 62 may opt to include user-specific information about a certain object 64 such that the information may be displayed upon a future identification of the object 64. Conversely, in some embodiments, the user may opt to delete or hide an object 64 from being identified and an indicator 70 associated therewith being displayed on the mobile device display 24.

Furthermore, in some instances, an object 64 may include one or more markers 66 identified by the object recognition application 14 that leads the object recognition application 14 to associate an object with more than one objects in the data storage 48. In such instances, the user 62 may be presented with multiple candidate identifications and may opt to choose the appropriate identification or input a different identification. The multiple candidates may be presented to the user 62 by any means. For instance, in one embodiment, the candidates are presented to the user 62 as a list wherein the “strongest” candidate is listed first based on reliability of the identification. Upon input by the user 62 identifying the object 64, the object recognition application 14 may “learn” from the input and store additional markers 66 in order to avoid multiple identification candidates for the same object 64 in future identifications.

Additionally, the object recognition application 14 may utilize other metrics for identification than identification algorithms. For instance, the object recognition application 14 may utilize the user's location, time of day, season, weather, speed of location changes (e.g., walking versus traveling), “busyness” (e.g., how many objects are in motion versus stationary in the video stream), as well any number of other conceivable factors in determining the identification of objects 64. Moreover, the user 62 may input preferences or other metrics for which the object recognition application 14 may utilize to narrow results of identified objects 64.

In some embodiments, the AR presentation application 17 may have the ability to gather and report user interactions with displayed indicators 70. The data elements gathered and reported may include, but are not limited to, number of offer impressions; time spent “viewing” an offer, product, object or business; number of offers investigated via a selection; number of offers loaded to an electronic wallet and the like. Such user interactions may be reported to any type of entity desired. In one particular embodiment, the user interactions may be reported to a financial institution and the information reported may include customer financial behavior, purchase power/transaction history, and the like.

In various embodiments, information associated with or related to one or more objects that is retrieved for presentation to a user via the mobile device may be permanently or semi-permanently associated with the object. In other words, the object may be “tagged” with the information. In some embodiments, a location pointer is associated with an object after information is retrieved regarding the object. In this regard, subsequent mobile devices capturing the object for recognition may retrieve the associated information, tags and/or pointers in order to more quickly retrieve information regarding the object. In some embodiments, the mobile device provides the user an opportunity to post messages, links to information or the like and associate such postings with the object. Subsequent users may then be presenting such postings when their mobile devices capture and recognize an object. In some embodiments, the information gathered through the recognition and information retrieval process may be posted by the user in association with the object. Such tags and/or postings may be stored in a predetermined memory and/or database for ease of searching and retrieval.

In some embodiments, AR application 17 and/or object recognition application 14 may include a sports movement information application configured to perform any of the processes and/or methods described herein.

In various embodiments, information associated with or related to one or more objects that is retrieved for presentation to a user via the mobile device may be permanently or semi-permanently associated with the object. In other words, the object may be “tagged” with the information. In some embodiments, a location pointer is associated with an object after information is retrieved regarding the object. In this regard, subsequent mobile devices capturing the object for recognition may retrieve the associated information, tags and/or pointers in order to more quickly retrieve information regarding the object. In some embodiments, the mobile device provides the user an opportunity to post messages, links to information or the like and associate such postings with the object. Subsequent users may then be presenting such postings when their mobile devices capture and recognize an object. In some embodiments, the information gathered through the recognition and information retrieval process may be posted by the user in association with the object. Such tags and/or postings may be stored in a predetermined memory and/or database for ease of searching and retrieval.

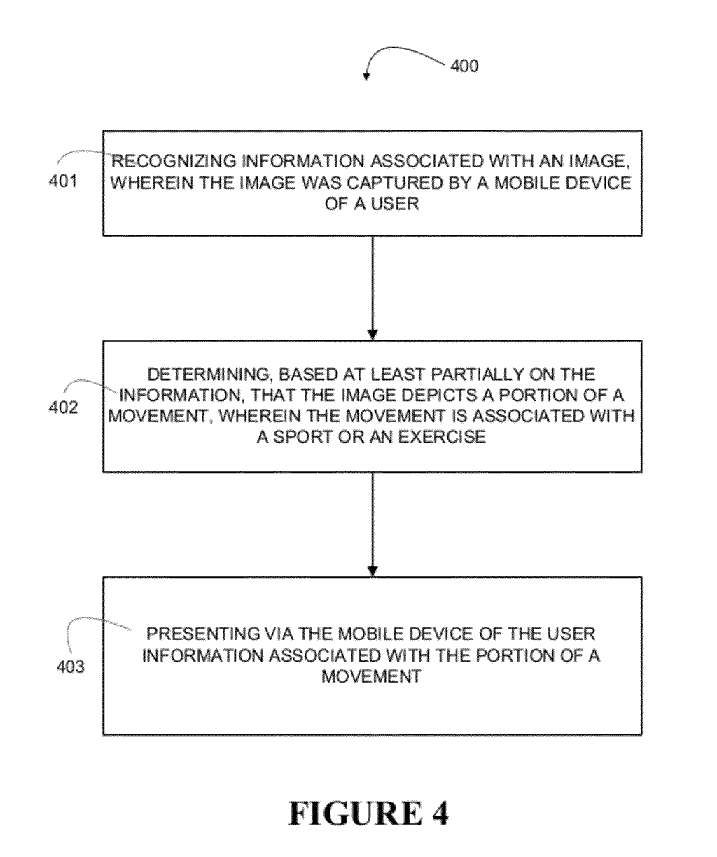

FIG. 4 depicts a process flow 400 in accordance with one aspect of the invention. As shown in element 401, the process flow includes recognizing information associated with an image, wherein the image was captured by a mobile device of a user. In some implementations of element 401, the mobile device is a mobile telephone. However, any database searches, executing data analysis applications or algorithms, or any other procedure wherein a portion of the information associated with the image is compared to another set or subset of data. For example, if information about an athlete's running posture is associated with an image, that information may be compared to data stored in a web-accessible database that identifies running techniques associated with famous and/or successful runners. In another example, such as an implementation that contemplates identifying an athletic motion within a the context of a physical locations, or an implementation that contemplates locating a piece of athletic equipment, GPS and compass directional data may be associated with an image, and that information may be compared to data stored in a web-accessible database that identifies major landmarks, buildings, portions of structures, or other features that are viewable from the position and orientation where the image was captured.

As depicted in element 402, process flow 400 includes determining, based at least partially on the information, that the image depicts a portion of a movement, wherein the movement is associated with a sport or an exercise. It will be appreciated that any movement associated with a sport or an exercise may be used in example implementations of element 402.

In some example implementations of element 402, the movement includes a running motion, including but not limited to a stride, a step, the positioning of a foot as it strikes and/or leaves the ground, a posture, an arm position while running, or any other movement associated with running. In some such implementations, and in other example implementations of element 402, the movement includes a jumping motion, such as a take-off, a landing, a leap, a leg position, or any other movement associated with jumping.

In example implementations of element 402, the image may depict a portion of other movements. For example, in some implementations, the movement includes a throwing motion, such as an arm, hand, and/or finger position, a release, a wrist movement, a body position, or any other movement associated with throwing. In some such implementations, and in other example implementations, the movement includes a catching motion, such as an arm, hand, and/or finger position, a body position, a head position, or any other movement associated with catching. In some such implementations, and in other example implementations of element 402, the movement is a striking motion, including but not limited to motions associated with punching, hitting, slapping, pushing, setting, spiking, or otherwise coming into contact with a ball, obstacle, piece of equipment, opponent, teammate, or other entity associated with a sport or an exercise.

In some example implementations of element 402, the image may depict a portion of movements that are often, but not necessarily associated with moving and/or manipulating a piece of equipment. For example, in some implementations, the movement includes a swinging movement, including but not limited to swinging movements associated with golf, baseball, softball, tennis, squash, racquetball, badminton, other racquet sports, fencing, and/or any other sport or exercise.

In some such implementations, and in other example implementations of element 402, the movement includes a kicking motion, including but not limited to kicking motions associated with soccer, martial arts, kickball, and/or any other sport or exercise.

In some implementations of element 402, the movement includes a swimming motion, including but not limited to swimming strokes, such a freestyle, backstroke, breaststroke, butterfly, sidestroke, dog-paddle, and/or any other motion that allows for a change of position through water and/or a maintenance of a position in water. In some such implementations, and in other example implementations, the movement is a twisting motion, including but not limited to motions associated with gymnastics, stretching, and/or other motions that involve twisting all or part of a body. In some such implementations, and in other example implementations, the motion includes a pushing motion, including but not limited to pushing motions utilizing equipment, and/or pushing motions associated with weightlifting, football, wrestling, other contact sports, fitness activities, and/or any other sport or exercise. In some such implementations, and in other example implementations of element 402, the movement includes a pulling motion, including but not limited to pulling motions utilizing equipment and/or associated with weightlifting, rowing, climbing, and/or any other sport or exercise.

Some example implementations contemplate recognizing equipment. It will be appreciated that any approach to recognizing equipment may be used in such implementations, including but not limited to recognizing shapes, design elements, logos, and/or other features that may permit one piece of equipment to be distinguished from another piece of equipment. For example, some professional athletes use equipment that is adorned with the logos of sponsors, such that the manufacturer's logo associated with the equipment may be obscured or even absent from the equipment. In an example implementation, a distinctive shape or pattern, such as a frame design of a bicycle, and/or a stitch pattern on a shoe, and/or any other potentially distinguishing characteristic may be used to identify the piece of equipment.

It will be appreciated that in example implementations of element 402, other categories of movements associated with a sport or an exercise may be used. In some such example implementations the movement may include any position of a body part. In some such implementations, and in other example implementations, the movement includes an extension of a body part, including but not limited to any movement where a muscle, limb, joint, digit, or other body part is extended. In some such implementations, and in other example implementations, the movement includes a flexion of a body part, including but not limited to any movement where a muscle, limb, joint, digit, or other body part is flexed.

In some example implementations, element 402 includes comparing the information with data stored in a memory system. Such memory systems may include any of the memory systems described herein with respect to FIGS. 1-3 and/or element 401 above. For example, in some implementations, information associated with the image may be compared to information stored in a memory system to detect difference between the portion of a movement depicted in the image and a previously captured image and/or an idealized representation of the movement and/or a similar movement.

As shown in FIG. 4, process flow 400 also includes element 403. As depicted in FIG. 4, element 403 includes presenting via the mobile device of the user information associated with the portion of a movement. Some example implementations of element 403 include the approaches described above with respect to FIGS. 1-3, including, but not limited to the implementation of a virtual image 300 as discussed with respect to FIG. 3. In some example implementations of element 403, the information associated with a portion of a movement includes an analysis of the portion of a movement. In some such example implementations, an analysis of the portion of a movement may show that a runner tends to overpronate, and information regarding overpronation may be presented via the mobile device to the user. In another example implementation, an analysis of the portion of a movement may show how a golfer's position and/or swing tends to cause a hook, slice, or other undesirable effect on the flight of the ball, and information identifying one or more potential problems and/or one or more potential adjustments may be presented to the user. In some example implementations, databases associated with such golf instruction institutions, or with other entities, may be polled to acquire data and perform an analysis and/or comparison to aspects of the captured image and/or video.

In some such example implementations, and on other example implementations that contemplate an analysis of the portion of a movement, the analysis may utilize information about the skill level of the user or other individual depicted in an image and/or video. For example, a novice participant may indicate that they are beginning a new sport or activity, and the information that is presented to the user may include introductory tips and techniques that are appropriate for a beginner instead of advanced techniques and instruction that would be more appropriate for a more seasoned participant.

In some example implementations of element 403, the information presented to the user includes an analysis of the user's body type. For example, based on the captured image and/or video, it may be possible to determine that the user has a relatively long reach for their height, relatively short legs, a relatively long torso, or other physical feature. In some such example implementations, and in other example implementations that contemplate information about a user's body type, information specific to such physical features or body types may be presented to the user. For example, a swimmer who is attempting to improve their performance may be presented with videos and/or other information about a professional swimmer with a similar body type, such that the user can incorporate the techniques used by the professional in the user's own efforts towards improvement.

In some other example implementations of element 403, the information associated with the portion of a movement may be information from a coach, instructor, or other professional. For example, the mobile device may be used to transmit the captured image and/or video to a coach who provides contemporaneous feedback to the user via the mobile device. In some such example implementations, and in other example implementations, users who are located remotely from coaches, trainers, and/or physicians can transmit images and/or videos of movements and engage in a dialogue regarding the progression of the user in improving their skill, recovering from injury, or otherwise performing the captured motion.

In some example implementations of element 403, the information associated with the portion of a movement includes an item of equipment. In one example implementation, a spectator unfamiliar with a particular sport may be able to use a mobile device to capture an image of a participant, and be presented with information about the equipment used in the sport, such as the name of the piece of equipment, how it is typically used, and other information regarding the piece of equipment. In another example implementation, the information presented via the mobile device is the brand name, model, and/or other identifying information of a specific piece of equipment that is depicted in an image. For example, a spectator could capture an image of the shoes worn by their favorite player, and, in accordance with an example implementation of process flow 400, be presented with information about the brand of the shoe, the model name, and/or where the spectator could purchase a pair of the same shoes.

Some implementations of element 403 include displaying an indicator on a display of the mobile device. This indicator may take the form of an icon or other image displayed on a screen integrated into the mobile device. In other implementations of element 403, presenting an indicator associated with the individual includes superimposing the indicator over real-time video and/or a still image that is captured by the mobile device. For example, an icon indicating an aspect of a movement may be superimposed near a depiction of the movement, or a border that surrounds a depiction of a piece of equipment may be rendered on the mobile device display.

Further example implementations of element 403 present an indicator that is selectable by the user. In implementations where the display of the mobile device can detect a touch from the user, the user may be able to touch the region of the display where the indicator is presented to select the indicator. In some such implementations of element 403, responsive to a selection of the indicator by the user, information about the movement and/or piece of equipment is presented on a display of the mobile device. For example, selecting the indicator may allow the user to access a hyperlink that directs the user to a website including information about the piece of equipment, such as the manufacturer's webpage, an online retailer, and/or a website with reviews of the piece of equipment. In other example implementations, the indicator itself is hyperlink that directs the user to a website including information about the movement, such as a website that offers tips about improving sports or exercise performance.

In some such implementations, and in other example implementations of element 403, or the overall method 400, the method includes presenting information about the individual via the mobile device of the user. In examples where information about the movement is stored in memory storage integrated with the mobile device, as discussed with respect to FIGS. 1-3, that information may be displayed or otherwise presented to the user. Examples of information that may be presented to the user include, but are not limited to, identifications of the movement, assessments of multiple similar movements taken over time, comparisons between movements performed by the same individual and/or a group of individuals, diagnostic information regarding the movement, preliminary injury diagnosis associated with the movement, and/or any other information associated with a portion of a movement.

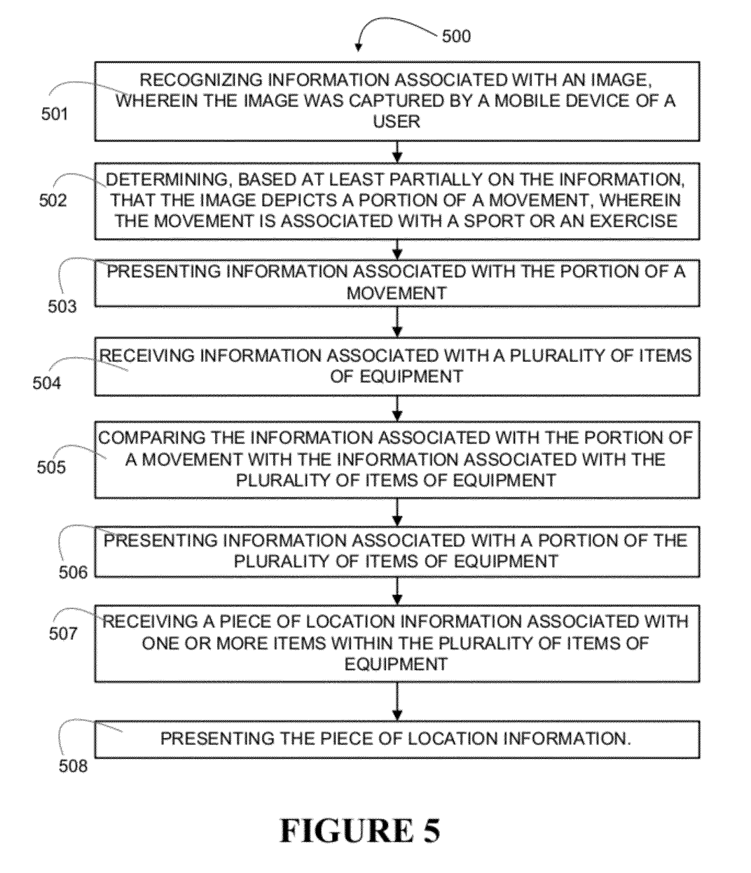

FIG. 5 depicts a process flow 500 in accordance with another aspect of the invention. As depicted at element 501, the process flow 500 includes recognizing information associated with an image, wherein the image was captured by a mobile device of a user. It will be appreciated that any approach to recognizing information associated with an image, wherein the image was captured by a mobile device of a user may be used in example implementations of element 501, including, but not limited to the approaches presented herein with respect to element 401 in FIG. 4.

As depicted at element 502, the process flow 500 includes determining, based at least partially on the information, that the image depicts a portion of a movement, wherein the movement is associated with a sport or an exercise. It will be appreciated that any approach to determining, based at least partially on the information, that the image depicts a portion of a movement, wherein the movement is associated with a sport or an exercise may be used in example implementations of element 502, including, but not limited to any approach presented herein with respect to element 402 in FIG. 4

FIG. 5 also includes a depiction of element 503, which includes presenting via the mobile device of the user information associated with the portion of a motion. It will be appreciated that any approach to presenting via the mobile device of the user a. Any of the implementations of presenting information via the mobile device as discussed with respect to FIGS. 1-4 above, including but not limited to the discussion with respect to element 403, may be applied to implementations of element 503.

Some example implementations contemplate a database and/or plurality of databases where information regarding equipment is stored and made accessible to a user of a mobile device. Such a database or databases may be public, private, or a combination of some publicly available information and some premium, fee-for-service information. For example, the information in a database may include advertising claims made by manufacturers regarding the specific characteristics of their products, and the situations that those products should be used in. In one such example, a database includes an identification of all running shoes that are designated as having extra support, motion control for overpronation, and/or other characteristics. In another example, the database includes information about golf clubs that have been tested by an independent party, such as a trade magazine, and have been identified as having an enlarged sweet spot, good balance, and/or other factors. It will be appreciated, however, that any information about a product may be included in the database, including but not limited to information about the applicability of the products to particular movements exhibited by potential purchasers.

Element 504 in FIG. 5 includes receiving via the mobile device of the user information associated with a plurality of equipment. Any approach to receiving information via the mobile device of the user may be used in example implementations of element 504, including, but not limited any of the approaches described herein with respect to FIGS. 1-4. In some example implementations, the information associated with a plurality of equipment includes an identification of pieces of equipment that the user may be interested in, based on prior purchases made by the user, information supplied by the user, and/or information associated with the captured image.

As depicted at element 505, example implementations of process flow 500 also include comparing the information associated with the portion of a movement with the information associated with the plurality of items of equipment. In some such implementations, comparing the information associated with the portion of a movement with the information associated with the plurality of items of equipment includes identifying aspects of the movement, identifying characteristics of one or more items in the plurality of items of equipment, and selecting pieces of equipment that may be appropriate for the movement mobile device capable of capturing an image may be used or be configured to be used in implementations of element 401. For example, a mobile device may be any device described in relation to FIGS. 1-3.

In element 401, the image captured by the mobile device may be any type of image and/or video, including without limitation a still image, video, high-speed video, real-time video, and/or any of the images and/or videos described in relation to FIGS. 1-3. For example, the image may be part of a video stream. In other example implementations of process flow 400, the image may be a still image captured by a digital camera. It will be appreciated that while many implementations will use images based on visible wavelengths of light, other implementations may use images including representations of non-visible wavelengths, such as those produced by cameras configured to perform infrared, ultraviolet, low-light, night-vision, or other image-capture functions.

As referred to in element 401, the information associated with the image may include any data included in, relating to, stored with, and/or used to render the image, including, without limitation, metadata. In some example implementations, the information includes Global Positioning System (GPS) coordinates and/or compass headings, either individually or in combination. In other example implementations, the information includes a portion of the image. The information may include any or all of the AR markers referred to in the discussion of FIGS. 1-3 above, or any other data described herein. Facial recognition data may also be included in the information associated with the image in element 401, in conjunction with or independent of any other type of information gathered when the image is captured.

In process flow 400, element 401 includes recognizing information associated with an image, wherein the image was captured by a mobile device of a user. In some implementations of element 401, recognizing information associated with an image includes comparing the information with data stored in a memory system. A memory system may include one or more of any of the computer-readable memory storage devices described in relation to FIGS. 1-3, and/or may include databases, websites, servers, or any other data-storage medium integrated into the mobile device or located remote to the mobile device and accessed by the mobile device via a network connection, air interface, or other connection. Comparing the information to data stored in a memory system may include performing depicted in the captured image. For example, if an analysis of the captured image suggests that a person overpronates while running, is left handed, plays volleyball, and/or has sustained an injury, such information can be compared to information associated with each piece of equipment and equipment that is likely to accommodate, correct, and/or improve aspects of the user's movements may be identified. In some such examples, information about physical characteristics, such as the body type of the user may be compared to information about equipment to identify items of equipment that are well-suited to the particular user. In some such implementations, and in other example implementations, the user's skill level may be taken into account such that lower-cost and/or entry-level pieces of equipment are identified for a beginner, while professional-grade pieces of equipment are presented for more advanced athletes.

In some example implementations of element 505, an analysis includes comparing identified characteristics of a movement with a database that associates such characteristics with products and/or correlates characteristics of a movement with design features of the product. In some such implementations, comparing the information associated with the portion of a movement with the information associated with the plurality of items includes matching the identified characteristics of the movement with equipment designed and/or marketed to accommodate, address, and/or improve those characteristics.

Element 506 includes presenting via the mobile device of the user information associated with a portion of the plurality of items of equipment. In some example implementations, information about specific pieces of equipment, such as equipment identified in example implementations of element 505, is presented to the user. It will be appreciated that any approach to presenting information to the user described herein, including, but not limited to the approaches described herein with respect to FIGS. 1-5 may be used in implementations of element 506.

In some implementation of element 506, the information associated with a plurality of items of equipment includes a recommendation of one or more items within the plurality of items of equipment. For example, a particular piece of equipment may be recommended by peers, professionals, and/or another source or authority as the best piece of equipment for a person exhibiting movements and/or traits similar to those of the user. In example implementations of element 506 that contemplate such a situation, the recommendation may be presented to the user.

In some such example implementations of element 506, the recommendation presented to the user may take into account a wishlist associated with a user. For example, a user may have previously identified several pieces of equipment that the user is considering purchasing, or would like to obtain in the future. In some such examples, the user's wishlist may be compared against equipment identified as recommended for the user to determine if the equipment desired by the user is well-suited to the user. In some other example implementations, information associated with the wishlist, such as a brand loyalty, equipment type, and other features of the equipment in the wishlist may be used to adjust one or more recommendations to the user, such that equipment made by the user's preferred brand, exhibiting the user's preferred design aesthetic, or containing certain design features common to equipment in the wishlist may be presented to the user. It will be appreciated that in some example implementations a wishlist may contemplate the automatic acceptance of specific predefined rules engines, such that when a recommendation or offer matches the predefined rules, a purchase of and payment for the product may be executed by the mobile device on behalf of the user. For example, a user's wishlist may indicate that he wants to purchase a tennis racquet or other piece of equipment suited to his style of play that fits within a particular price range. When such a piece of equipment is identified, such as in an example implementation of process flow 500 and/or element 506, the mobile device may execute the purchase of and payment for the piece of equipment.

As shown at element 507, process flow 500 also includes receiving via the mobile device of the user a piece of location information associated with one or more items within the plurality of equipment. In some example implementations of element 507, the location information is a location where the user can purchase the equipment. In some such example implementations, the location information includes a map, GPS coordinates, directions, and/or other indicia of locations where the equipment can be purchased. In some such example implementations, and in other example implementations, the location information may include a specific indication of where, within a store or other location, the desired items can be found. It will be appreciated that any of the approaches to receiving information described herein may be used in example implementations of element 507, including but not limited the approaches described with respect to FIGS. 1-5. It will also be appreciated that example implementations of 507 may use any type or types of location information, alone or in combination, including but not limited to any of the types of location information described herein. In some such example implementations, the location information includes GPS coordinates, positional information, compass directions, orientation information such as roll, pitch, and/or yaw, image and/or feature recognition, and or any other approach to identifying a location.

Process flow 500 also includes element 508, which presenting via the mobile device of the user the piece of location information. It will be appreciated that any approach to presenting information via the mobile device of the user may be used in example implementations of element 508, including but not limited to any of the approaches described herein with respect to FIGS. 1-5.

### ILLUSTRATIVE EXAMPLE IMPLEMENTATIONS

With respect to the methods above, several example implementations are presented herein. These illustrative example implementations are presented merely to indicate some of the situations and scenarios in which some of the described and claimed methods may be performed. The illustrative example implementations are not exclusive and are not intended to define the full scope or limits on the scope of the claims, but rather are provided to assist in understanding aspects of the invention described and claimed herein. It will be appreciated that many of the details presented in the illustrative example implementations may be altered without placing the resulting scenario outside the scope of the invention.

### Illustrative Example 1

A user is a beginning golfer is having difficulty with hitting the ball in a consistent manner. The user captures a series of short videos of his attempts of a variety of shots with each of his clubs. An application running on the mobile device determines that the captured video depicts golf swings, analyzes the user's swing, and presents to the user a comparison video showing how the user tends to move his body in an unpredictable manner as the club approaches the ball, causing the inconsistencies experienced by the user. The analysis of the videos also indicates that the user's golf clubs are much to short for him, and presents the user with the addresses of a number of reputable shops nearby where the user can have his clubs re-shafted to properly fit the user.

### Illustrative Example 2

A user is a runner who is experiencing an unusual degree of discomfort after her runs. The user captures a video of herself running, and a portion of the video includes a depiction of how her feet hit the ground when she runs. An analysis of the video indicates that the user tends to overpronate when she runs, and indicates that her shoes are a poor match for runners that tend to overpronate. A depiction of the user's foot-strike on the ground is presented on the display of the user's mobile device, along with a link to a website describing how overpronation may cause the discomfort experienced by the user. A link to a website describing the best shoes for overpronating runners is also displayed on the user's mobile device. By selecting the link, the user is able to obtain information about better running shoes, which she subsequently orders via her mobile device.

### Illustrative Example 3

A user's child is an avid fan of a particular soccer star, and routinely asks the user for a replica of the star's jersey. While at a match involving the star's team, the user captures a digital photograph of the star as he runs towards the ball. An application on the user's mobile device recognizes that the image depicts the star playing soccer, and places an indicator in the form of a border around the portion of the depiction that contains the star's jersey. The user selects the indicator and is redirected to a list of shops that carry replicas of the jersey. At a later date, the user goes to one of the shops, but has a difficult time finding the jersey within the shop. Using his mobile device, the user captures a real-time video stream of the store, and an indication of the location of the jersey within the store is superimposed on the real-time video stream. The user is able to successfully select and purchase the jersey from the store and surprise his child with a gift.

Thus, methods, systems, computer programs and the like have been disclosed that provide for using real-time video analysis, such as AR or the like to assist the user of mobile devices with commerce activities. Through the use real-time vision object recognition objects, logos, artwork, products, locations and other features that can be recognized in the real-time video stream can be matched to data associated with such to assist the user with commerce activity. The commerce activity may include, but is not limited to; conducting a transaction, providing information about a product/service, providing rewards based information, providing user-specific offers, or the like. In specific embodiments, the data that matched to the images in the real-time video stream is specific to financial institutions, such as customer financial behavior history, customer purchase power/transaction history and the like. In this regard, many of the embodiments herein disclosed leverage financial institution data, which is uniquely specific to financial institution, in providing information to mobile devices users in connection with real-time video stream analysis.

The systems, methods, computer program products, etc. described herein, may be utilized or combined with any other suitable AR-related application. Non-limiting examples of other suitable AR-related applications include those described in the following U.S. Provisional Patent Applications, the entirety of each of which is incorporated herein by reference:

| U.S. | | |
|---|---|---|
| Provisional | | |
| Ser. No. | Filed On | Title |
| 61/450,213 | Mar. 8, 2011 | Real-Time Video Image Analysis |
| | | Applications for Commerce Activity |
| 61/478,409 | Apr. 22, 2011 | Presenting Offers on a Mobile |
| | | Communication Device |
| 61/478,412 | Apr. 22, 2011 | Real-Time Video Analysis for Reward |
| | | Offers |
| 61/478,394 | Apr. 22, 2011 | Real-Time Video Image Analysis for |
| | | Providing Targeted Offers |
| 61/478,399 | Apr. 22, 2011 | Real-Time Analysis Involving Real Estate |
| | | Listings |
| 61/478,402 | Apr. 22, 2011 | Real-Time Video Image Analysis for an |
| | | Appropriate Payment Account |
| 61/478,405 | Apr. 22, 2011 | Presenting Investment-Related Information |
| | | on a Mobile Communication Device |
| 61/478,393 | Apr. 22, 2011 | Real-Time Image Analysis for Medical |
| | | Savings Plans |
| 61/478,397 | Apr. 22, 2011 | Providing Data Associated With |
| | | Relationships Between Individuals and |
| | | Images |
| 61/478,408 | Apr. 22, 2011 | Identifying Predetermined Objects in a |
| | | Video Stream Captured by a Mobile |
| | | Device |
| 61/478,400 | Apr. 22, 2011 | Real-Time Image Analysis for Providing |
| | | Health Related Information |
| 61/478,411 | Apr. 22, 2011 | Retrieving Product Information From |
| | | Embedded Sensors Via Mobile Device |
| | | Video Analysis |
| 61/478,403 | Apr. 22, 2011 | Providing Social Impact Information |
| | | Associated With Identified Products or |
| | | Businesses |
| 61/478,407 | Apr. 22, 2011 | Providing Information Associated With an |
| | | Identified Representation of an Object |
| 61/478,415 | Apr. 22, 2011 | Providing Location Identification of |
| | | Associated Individuals Based on |
| | | Identifying the Individuals in Conjunction |
| | | With a Live Video Stream |
| 61/478,419 | Apr. 22, 2011 | Vehicle Recognition |
| 61/478,417 | Apr. 22, 2011 | Collective Network of Augmented Reality |
| | | Users |
| 61/508,985 | Jul. 18, 2011 | Providing Information Regarding Medical |
| | | Conditions |
| 61/508,946 | Jul. 18, 2011 | Dynamically Identifying Individuals |
| | | From a Captured Image |
| 61/508,980 | Jul. 18, 2011 | Providing Affinity Program Information |
| 61/508,850 | Jul. 18, 2011 | Assessing Environmental Characteristics |
| | | in a Video Stream Captured by a |
| | | Mobile Device |
| 61/508,966 | Jul. 18, 2011 | Real-Time Video Image Analysis for |
| | | Providing Virtual Landscaping |
| 61/508,969 | Jul. 18, 2011 | Real-Time Video Image Analysis for |
| | | Providing Virtual Interior Design |
| 61/508,971 | Jul. 18, 2011 | Real-Time Video Image Analysis for |
| | | Providing Deepening Customer Value |
| 61/508,764 | Jul. 18, 2011 | Conducting Financial Transactions |
| | | Based on Identification of Individuals in |
| | | an Augmented Reality Environment |
| 61/508,973 | Jul. 18, 2011 | Real-Time Video Image Analysis for |
| | | Providing Security |
| 61/508,976 | Jul. 18, 2011 | Providing Retail Shopping Assistance |
| 61/508,944 | Jul. 18, 2011 | Recognizing Financial Document Images |

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method comprising:
recognizing information associated with an image, wherein the image was captured by a mobile device of a user;
determining, based at least partially on the information, that the image depicts a portion of a movement, wherein the movement is associated with a sport or an exercise; and
presenting via the mobile device of the user information associated with the portion of a movement.

2. The method of claim 1, wherein the movement comprises a running motion.

3. The method of claim 1, wherein the movement comprises a jumping motion.

4. The method of claim 1, wherein the movement comprises a throwing motion.

5. The method of claim 1, wherein the movement comprises a catching motion.

6. The method of claim 1, wherein the movement comprises striking motion.

7. The method of claim 1, wherein the movement comprises a swinging motion.

8. The method of claim 1, wherein the movement comprises a kicking motion.

9. The method of claim 1, wherein the movement comprises a swimming motion.

10. The method of claim 1, wherein the movement comprises a twisting motion.

11. The method of claim 1, wherein the movement comprises a position of a body part.

12. The method of claim 1, wherein the movement comprises a pushing motion.

13. The method of claim 1, wherein the movement comprises a pulling motion.

14. The method of claim 1, wherein the movement comprises an extension of a body part.

15. The method of claim 1, wherein the movement comprises a flexion of a body part.

16. The method of claim 1 wherein the information associated with the portion of a movement comprises an analysis of the portion of a movement.

17. The method of claim 1 wherein the information associated with the portion of a movement comprises an item of equipment.

18. The method of claim 1 further comprising:
receiving via the mobile device of the user information associated with a plurality of items of equipment;
comparing the information associated with the portion of a movement with the information associated with the plurality of items of equipment; and
presenting via the mobile device of the user information associated with a portion of the plurality of items of equipment.

19. The method of claim 18 wherein the information associated with a portion of the plurality of items of equipment comprises a recommendation of one or more items within the plurality of items of equipment.

20. The method of claim 19 further comprising:
receiving via the mobile device of the user a piece of location information associated with the recommendation of one or more items within the plurality of items of equipment; and
presenting via the mobile device of the user the piece of location information.

21. An apparatus for providing sports movement information, the apparatus comprising:
a computing device comprising a memory and at least one processor; and
a sports movement information application stored in memory, executable by the processor, and configured to:
recognize information associated with an image, wherein the image was captured by a mobile device of a user;
determine, based at least partially on the information, that the image depicts a portion of a movement, wherein the movement is associated with a sport or an exercise; and
present via the mobile device of the user information associated with the portion of a movement.

22. The apparatus of claim 21, wherein the movement comprises a running motion.

23. The apparatus of claim 21, wherein the movement comprises a jumping motion.

24. The apparatus of claim 21, wherein the movement comprises a throwing motion.

25. The apparatus of claim 21, wherein the movement comprises a catching motion.

26. The apparatus of claim 21, wherein the movement comprises striking motion.

27. The apparatus of claim 21, wherein the movement comprises a swinging motion.

28. The apparatus of claim 21, wherein the movement comprises a kicking motion.

29. The apparatus of claim 21, wherein the movement comprises a swimming motion.

30. The apparatus of claim 21, wherein the movement comprises a twisting motion.

31. The apparatus of claim 21, wherein the movement comprises a position of a body part.

32. The apparatus of claim 21, wherein the movement comprises a pushing motion.

33. The apparatus of claim 21, wherein the movement comprises a pulling motion.

34. The apparatus of claim 21, wherein the movement comprises an extension of a body part.

35. The apparatus of claim 21, wherein the movement comprises a flexion of a body part.

36. The apparatus of claim 21, wherein the information associated with the portion of a movement comprises an analysis of the portion of a movement.

37. The apparatus of claim 21 wherein the information associated with the portion of a movement comprises an item of equipment.

38. The apparatus of claim 21 further wherein the sports movement information application is further configured to:
receive via the mobile device of the user information associated with a plurality of items of equipment;
compare the information associated with the portion of a movement with the information associated with the plurality of items of equipment; and
present via the mobile device of the user information associated with a portion of the plurality of items of equipment.

39. The apparatus of claim 38 wherein the information associated with a portion of the plurality of items of equipment comprises a recommendation of one or more items within the plurality of items of equipment.

40. The apparatus of claim 39 wherein the sports movement information application is further configured to:
receive via the mobile device of the user a piece of location information associated with the recommendation of one or more items within the plurality of items of equipment; and
present via the mobile device of the user the piece of location information.

41. A computer program product comprising:
a non-transitory computer-readable medium comprising:
a first set of codes for causing a computer processor to be configured for recognizing information associated with an image, wherein the image was captured by a mobile device of a user;
a second set of codes for causing a computer processor to be configured for determining, based at least partially on the information, that the image depicts a portion of a movement, wherein the movement is associated with a sport or an exercise; and
a third set of codes for causing a computer processor to be configured for presenting via the mobile device of the user information associated with the portion of a movement.

42. The computer program product of claim 41, wherein the movement comprises a running motion.

43. The computer program product of claim 41, wherein the movement comprises a jumping motion.

44. The computer program product of claim 41, wherein the movement comprises a throwing motion.

45. The computer program product of claim 41, wherein the movement comprises a catching motion.

46. The computer program product of claim 41, wherein the movement comprises striking motion.

47. The computer program product of claim 41, wherein the movement comprises a swinging motion.

48. The computer program product of claim 41, wherein the movement comprises a kicking motion.

49. The computer program product of claim 41, wherein the movement comprises a swimming motion.

50. The computer program product of claim 41, wherein the movement comprises a twisting motion.

51. The computer program product of claim 41, wherein the movement comprises a position of a body part.

52. The computer program product of claim 41, wherein the movement comprises a pushing motion.

53. The computer program product of claim 41, wherein the movement comprises a pulling motion.

54. The computer program product of claim 41, wherein the movement comprises an extension of a body part.

55. The computer program product of claim 41, wherein the movement comprises a flexion of a body part.

56. The computer program product of claim 41, wherein the information associated with the portion of a movement comprises an analysis of the portion of a movement.

57. The computer program product of claim 41, wherein the information associated with the portion of a movement comprises an item of equipment.

58. The computer program product of claim 41 further comprising:
a fourth set of codes for causing a computer processor to be configured for receiving via the mobile device of the user information associated with a plurality of items of equipment;
a fifth set of codes for causing a computer processor to be configured for comparing the information associated with the portion of a movement with the information associated with the plurality of items of equipment; and
a sixth set of codes for causing a computer processor to be configured for presenting via the mobile device of the user information associated with a portion of the plurality of items of equipment.

59. The computer program product of claim 58 wherein the information associated with a portion of the plurality of items of equipment comprises a recommendation of one or more items within the plurality of items of equipment.

60. The computer program product of claim 19 further comprising:
a set of codes for causing a computer processor to be configured for receiving via the mobile device of the user a piece of location information associated with the recommendation of one or more items within the plurality of items of equipment; and
a set of codes for causing a computer processor to be configured for presenting via the mobile device of the user the piece of location information.
